(19) United States
(12) Patent Application Publication
(10) Pub. No.: US 2002/0127916 A1
(43) Pub. Date: Sep. 12, 2002

(54) Electrical connectors

(76) Inventor: Hongxue Zhang, Oulu (FI)

Correspondence Address: ALTERA LAW GROUP, LLC, 6500 CITY WEST PARKWAY, SUITE 100, MINNEAPOLIS, MN, 55344, US

(21) Appl. No.: 09/871,455

(22) Filed: May 31, 2001

Related U.S. Application Data
(63) Continuation of application No. PCT/EP98/07835, filed on Dec. 2, 1998.

(51) Int. Cl. H01R 13/648

(52) U.S. Cl. 439/607

(57) ABSTRACT

A connector for connecting circuitry to a surface has a one piece body. The one piece body defines a cavity in which a portion of the circuitry is, in use arranged to be received. The cavity is defined by the one piece body. Fixing means are provided for fixing the connector to the surface.

The present invention relates to connectors and in particular, but not exclusively, to connectors for use with printed circuit boards.

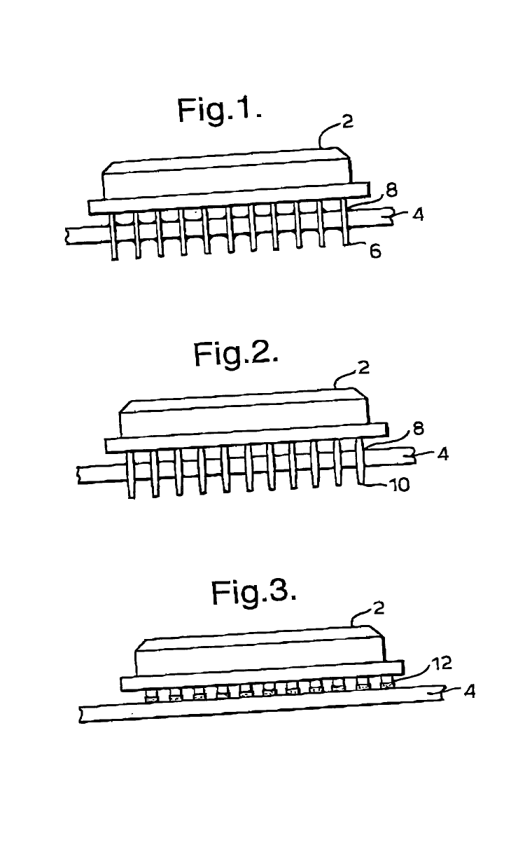

A number of different techniques are known for attaching components to a printed circuit board. FIG. 1 shows a component 2 which is attached to a printed circuit board 4 using the is through hole technique. The pins 6 of the component 2 are smaller than corresponding holes 8 provided in the printed circuit board 4 to accommodate the pins. Accordingly, to retain the component 2 in place, a solder bond is established between the pins 6 and the holes 8. The solder connection is typically achieved using a wave soldering technique.

FIG. 2 shows the component 2 attached to the printed circuit board 4 using a press fit technique. The pins 10 of the component 2 are designed so that when the pins 10 are inserted into the respective holes 8 of the printed circuit board, the component 2 is retained in place. In order to fit the component 2 to the printed circuit board, a mechanical force must be applied to the component 2 to push the pins 10 through the holes 8. The pins are slightly larger than the holes so that the pins are compressed by the holes during insertion. The pins are therefore retained in the hole.

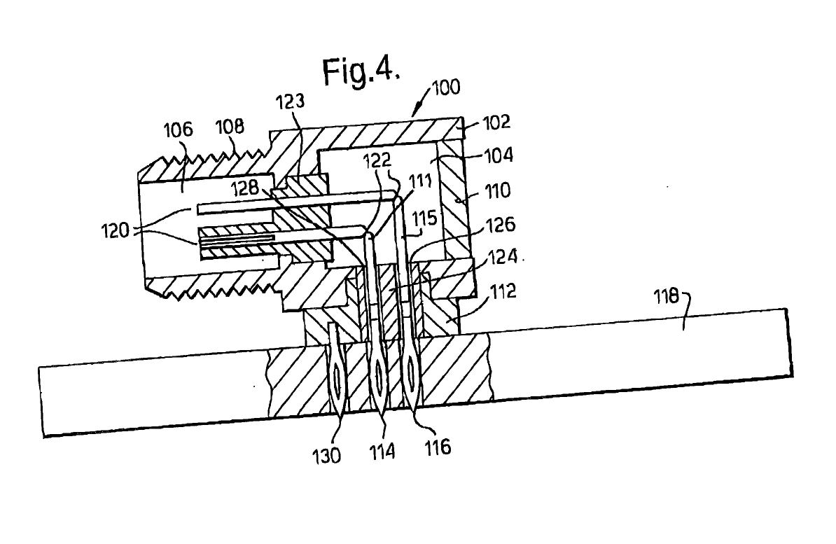

FIG. 3 shows the surface mounting technique which allows the component 2 to be mounted to the surface of the printed circuit board 4. Unlike the arrangements shown in FIGS. 1 and 2, the pins 12 of the component 2 are not received within holes of the printed circuit board. Instead, the surface of the printed circuit board 4 is coated with a patterned layer of copper and a layer of solder is applied thereon. The component 2 is positioned in the desired location and the solder on the printed circuit board 4 is heated. The heated solder melts and allows the pins 12 of the component to be bonded to the printed circuit board.

Each of these techniques have various advantages and disadvantages. The through hole technique illustrated in FIG. 1 provides good mechanical strength and reliable connections. However, it can be difficult to incorporate this method in automated small mechanical device production lines because it requires dedicated machinery. The press fit technique provides an acceptable degree of mechanical strength and eliminates the requirement for a separate soldering process. Again, separate machinery is generally required to carry out the press fit technique. The surface mounting technique is generally compatible with some automation processes so that no additional machinery is required but the mechanical strength provided may not be sufficient if the element is heavy.

In the field of telecommunications, and in particular in base stations, it is usual to connect relatively large connectors to a printed circuit board. These connectors allow, for example, external wires to be connected to signal terminals. One known connector 100 is shown in FIG. 4.

The connector shown in FIG. 4 comprises a metal housing 102 with a first part partially defining a cavity 104. The metal housing 102 has a second cylindrical part 106, the outside of which has a screw thread 108. The first part is substantially cubular. The connector 100 has a rear cover 110 which closes off the end of the cavity 104 of the housing 102. As will be discussed in more detail hereinafter, the rear cover 110 is only put, in place after the connections have been made to signal pins. The connector 100 also has a bottom cover 112 which is attached to the metal housing 102 by a pressfit connection. This closes the bottom of the cavity 104. Board connection pins 114 and 116 are inserted into sockets 126 and 128 in an insulator 124. The sockets have conductive walls. The sockets 126 and 128 extend through the bottom cover 112 and the metal housing 102. The board connections pins 114 and 116 only extend a relatively short distance into the sockets 127 and 129 and are arranged to provide a press fit connection to the printed circuit board 118. The signal connection pins 111 and 115 are inserted into the other ends of the sockets 127 and 128 and are connected at one end to signal pins 120. The signal connection pins 111 and 115 are connected to the signal pins 120 by a solder connection 122. The signal pins extend along at least part of the length of the metal housing 102, parallel to the axis thereof. The signal pins 120 are supported in the housing by an insulator plug 123 which separates the signal pins 120 from each other and from the housing 102 as well as retaining them in place. The board connection pins 114 and 116 and signal connection pins 111 and 115 are separated by the insulator 124 which surrounds part of the board connection pins 114 and 116 and part of the signal connection pins 111 and 115.

Further pins 130 are provided, one of which is shown in FIG. 4. The further pins 130 are accommodated only in the metal bottom cover 112 and provide a press-fit connection to the printed circuit board 118. The further pins 130 provide a grounding function and ground the connector 100.

The connector shown in FIG. 4 has a number of disadvantages. Firstly, the connector needs to be large enough to provide a cavity for the manual solder connections 122. This means that additional mechanical fixing members such as screws may be required for the heavy body of the connector. Accordingly, the connector is not compatible with the same small mechanical device processes which are normally able to handle, for example, the much smaller integrated circuits which are attached to the same circuit board. This means that a separate machine is required to handle the connector. Additionally, the use of pressfit pins also requires that a relatively large amount of force be applied to the connector in order to fix it in place on the circuit board. This means that additional machinery is required in order to make the pressfit connection. Furthermore, the connection of the signal pins is complicated and this does not lead to ease of automation. The construction is such that the signal electrodes are not directly connectable to the printed circuit board. Rather, the signal electrodes have to be connected to the pins 111 and 113 which are in the sockets 126 and 128 inside the connector housing. This causes complexity from the manufacturing view point and also degrades signal transmission. The connector is also relatively expensive.

It is therefore an aim of embodiments of the present invention to provide a connector which overcomes the disadvantages of the known connectors.

According to one aspect of the present invention, there is provided a connector for connecting circuitry to a surface, said connector comprising: a one piece body, said one piece body defining a cavity in which a portion of said circuitry is, in use arranged to be received, said cavity being defined by said one piece body; and fixing means for fixing said connector to said surface.

Thus, the connector may have a simpler construction as compared to the known connector in that a one piece body is provided The fixing means may be separate or integral with the connector body. Even if the fixing means are separate from the connector body, the resulting construction may be much simpler than that of the prior art connector. The connector may have a lower profile, smaller size and light weight due to its construction as compared to the prior art. This facilitates automatic assembly. The manufacture of the connector embodying the invention may be simpler and cheaper than that of the prior art.

The body may be arranged to receive a first portion of said circuitry, said body having a first opening and a second opening, wherein in use, a second portion of said circuitry is outside said connector body and is connected to said first portion via said first opening and a third portion of said circuitry is connected to the first portion via said second opening and is connected to said surface. The mechanism by which the connector allows the circuitry to be connected to the surface is, in certain embodiments of the present invention, simpler than the prior art connector. In particular, by providing the connection to the surface externally of the connector, the complicated connection between the signal pins and the signal connection pins of the known connector can be avoided. This means that it may be simpler to assemble and mount circuitry to the surface.

Preferably at least one spacer is provided so that when circuitry is connected to said surface, said body is spaced from said surface. This is particularly advantageous where the connector is fixed to the surface by a solder connection which is activated by the flow of hot air over the surface. By ensuring that hot air is able to get under the connector, a secure connection between the connector and the surface may be achieved. The at least one spacer may comprise a plurality of feet and in particular may comprise four feet. This is particularly preferred where the lower surface of the connector has a square or rectangular configuration. In those circumstances, a foot may be provided at each corner thereof. The at least one spacer is preferably integral with the body. This makes the connector simpler and does not require any complex assembly process.

Preferably, at least one pin member is provided, said pin member comprising a plurality of pins which are connected together at one; end region, said body having a plurality of openings for receiving at least some of said pins, wherein in use at least one of said pins is used to fix said body to the surface. This arrangement may be much simpler to implement that in the prior art connector. The preferred embodiment of the present invention may use two pin members. Preferably, at least one pin is arranged to be connected to the circuit board by a solder connection. This is particularly advantageous when used in combination with the feature that the connector body is spaced from the surface. The plurality of pins of the or each pin member may be arranged in a row.

The or each pin member may comprise a first type of pin for connecting said pin member to the body and a second type of pin for connecting said connector to the surface. Preferably, the first type of pin is arranged to make contact with the body of the connector. This means that the connector can be grounded with respect to the surface. The first type of pin may be received in at least one opening of the connector body with a pressfit connection. The at least one opening may have a circular cross section and the first type of pin may have a square cross section. Alternatively, other types of connection may be possible between the first type of pin and the connector body. For example, a solder connection may be provided therebetween. Preferably, the or each opening of the body of the second type of pin is dimensioned to allow the second type of pin to pass therethrough. In other words, the type of connection achieved with the pressfit connection of the first type of pin is not achieved. This is advantageous in that the heat transfer between the second type of pin and the connector body is reduced. This means that the heat which is used to mike a solder connection between the second type of pin and the surface is not conducted away from the area which is required to be soldered.

Preferably, the first type of pin is shorter than the second type of pin. The first type of pin is accommodated completely or the majority thereof is accommodated within the opening of the connector body.

Preferably, a plurality of the first type of pin and a plurality of the second type of pin are provided and the first and second types of pin are alternatively arranged, preferably in a row.

The portion of the circuitry received in the body may comprise signal pins. These signal pins may be connected at one end to the surface and at the other end to an external circuit element.

The connector body may comprise metal. The metal may be one or more of the following materials: brass; copper; aluminium; and aluminum alloy. It is preferred that the connector body be made of a “soft” petal which is lightweight and easy to use.

Preferably, the upper surface of the connector is flat. The upper surface is with respect to the surface to which the connector is to be fixed. This facilitates handling of the connector.

The connector may comprise an insulator part in the body for positioning the at least a portion of the circuitry in said body. The insulator part may only be inserted into the connector when the connector is to be mounted on the surface. The insulator prevents the portion of the circuitry within the body from making electrical contact therewith.

Preferably, the surface is a printed circuit board. In preferred embodiments of the present invention, the connector is incorporated in a base transceiver station.

According to a second aspect of the present invention, there is provided a connector for connecting circuitry to a surface, said connector comprising a body which is arranged to receive a first portion of said circuitry, said body having a first opening and a second opening, wherein in use, a second portion of said circuitry is outside said connector body and is connected to said first portion via said first opening and a third portion of said circuitry is connected to said first portion via said second opening and is connected to said surface.

According to a third aspect of the present invention there is provided a connector for connecting circuitry to a surface, said connector comprising: a body which is arranged to receive at least a portion of said circuitry; and at least one spacer so that when said circuitry is connected to said surface, said body is spaced from said surface.

According to a fourth aspect of the present invention, there is provided a connector for connecting circuitry to a surface, said connector comprising: a body which is arranged to receive at least a portion of said circuitry; and at least one pin member comprising a plurality of pins which are connected together at one end region, said body having a plurality of openings for receiving at least some of said pins, wherein in use at least one of said pins is used to fix said body to said surface.

For a better understanding of the present invention and as to how the same may be carried into effect, reference will now be made by way of example only to the accompanying drawings in which:

FIG. 1 illustrates the through hole technique;

FIG. 2 illustrates the press fit technique;

FIG. 3 illustrates the surface mounted technique;

FIG. 4 shows the construction of a known connector;

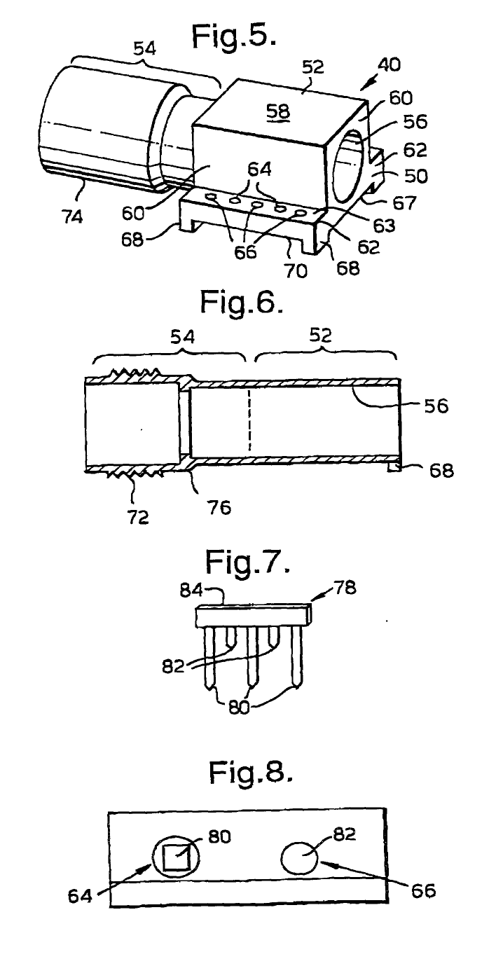

FIG. 5 shows a perspective view of a connector body of a connector embodying the present invention;

FIG. 6 shows a cross section through part of the connector body of FIG. 5;

FIG. 7 shows a pin strip for use with the connector body shown in FIG. 5;

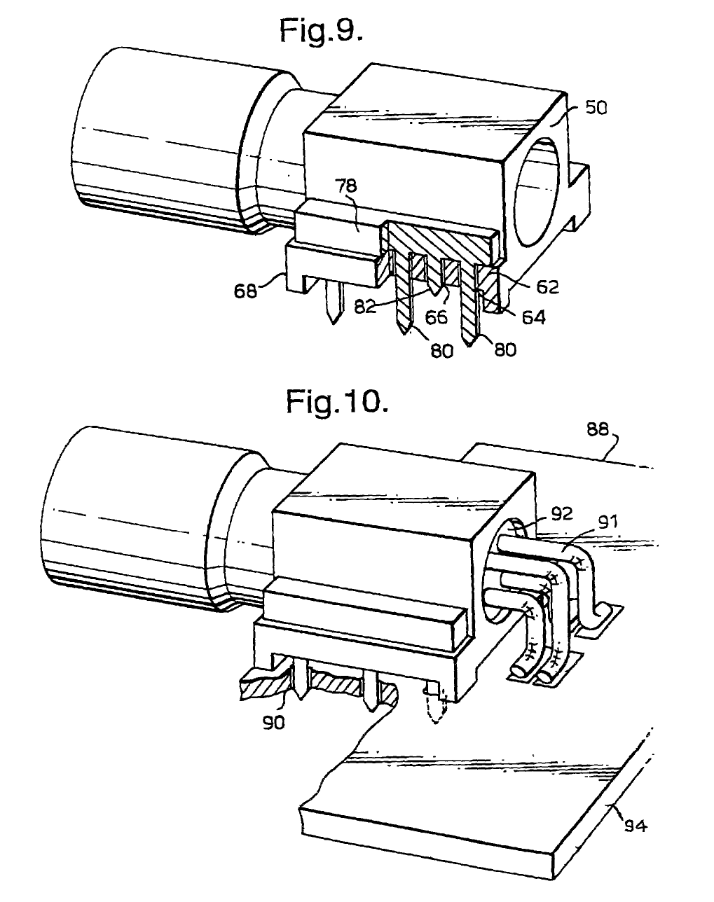

FIG. 9 illustrates the connection between the connector body of FIG. 5 and the pin strip of FIG. 7;

FIG. 9 shows a perspective view of the connector body of FIG. 5 and the pin strip of FIG. 7, with part of the connector body and pin strip cut away for clarity; and

FIG. 10 shows the connector embodying the present invention as attached to a printed circuit board,

A connector 40 embodying of the present invention will now be described with reference to FIGS. 5 to 10. The connector 40 comprises a connector body 50 which is shown in FIG. 5 and in cross section in FIG. 6. The connector body can be regarded as being made up of a first part 52 and a second part 54. The first part 52 has a hollow, cylindrical interior 56 which extends along the main axis of the connector body 50. In fact this hollow cylindrical interior 56 extends the entire length of the connector 40, through both the first and the second parts 52 and 54. Whilst the interior of the first part is cylindrical, the exterior of the first part has a flat top 58 and two flat planar sides 50 extending at right angles to the flat top. The flat top and flat sides 58 and 60 are planar and generally rectangular. This facilitates handling of the connector. Extending from the bottom of each of the flat sides 60 is a projecting portion 62 which as described hereinafter is used for connecting the body 50 to a printed circuit board.

Each projecting portion 62 has a flat outwardly extending upper surface 63 which extends at right angles to the lower portion of the respective flat side wall 60. The plane of the upper surface 63 of the projecting portion 62 is parallel to that of the flat top 58. Each projecting portion 62 has a plurality of openings 64 and 66 extending therethrough from the upper surface 63 to a lower surface 70. These openings will be described in more detail hereinafter. These openings extend through the projecting portion 62 and the axis of each of these openings 64 and 66 extends parallel to the plane of the flat sides 60. The lower surface 70 of each projecting portion 62 is connected to two feet 68. Each foot is arranged at an end of the projecting portion 62 and supports the connector body. A gap is defined by these feet 68 between the surface on which the connector is mounted and the lower surface 70 of the respective projecting portion 62. It should be appreciated that the lower surface 70 of each of the projecting portions 62 and the bottom 67 of the first part 52 are all coplanar.

The second part 54 of the connector 40 is substantially cylindrical both in the interior and on the exterior. As can be seen from FIG. 6, the outside of the cylindrical body has a threaded portion 72 which allows an external nut 74 (which is shown in FIG. 5 but not FIG. 6) to be fitted thereto. This nut 74 does not form part of the connector body itself. It should be noted that the interior of the second part 54 has two different diameters. The adjacent parts of the first and second parts 52 and 54 have the same diameter. The diameters can alternatively be different at the adjacent parts of the first and second parts 52 and 54. At the end of the second part 54 remote from the first part 52 there is a slightly larger, constant diameter cylindrical portion A step 76 is provided between the first and second diameters of the second part 54. This step 76 extends inwardly to define a ring and the diameter at the location of the step 76 is less than the diameter at any other point along the connector body 50.

The connector body shown in FIG. 5 is arranged to be used with two pin strips 78 which are shown in FIG. 7. The pin strip shown in FIG. 7 has five pins. There are three pins 80 of a first type and two pins 82 of a second type. The first type of pins 80 are much longer than the second type of pins 82. The first and second type of pins 80 and 82 are arranged in a single line alternately. The top end of each of the pins 80 and 82 are connected to a single support 84.

Two pin strips 78 are used with each connector body 50. In particular, one pin strip 78 is used with each projecting portion 62. The pins 80 and 82 are inserted in the respective openings 64 and 66 of the respective projecting portion 62 as can be seen in FIG. 9. The diameter of the first set of openings 64 which receive the first set of pins 80 are generally larger than the diameter of the first pins so that the first pins 80 can be easily inserted in the first holes without the application of force. The first set of openings 64 may have a circular cross-section whilst the first type of pins 80 may have a square cross-section. This is illustrated in FIGS. 8 and 9. Alternatively any other suitable shapes can be used for the cross-sections of the first set of openings 64 and the first type of pins.

However the diameter of the second set of openings 66 is much closer to the diameter of the second pins 82. Accordingly, force needs to be applied to the pin strip 78 in order to push the second pins 82 through the respective holes 66. Effectively, a press fit connection is established between the pin strip 78 and the connector body 50 via the second pins 82.

Reference is made to FIG. 8 which shows on the left hand side one of the first pins 80 as received in the corresponding hole 64 of the connector body 50 As can be seen, the first pin 80 has a smaller diameter than the diameter of the corresponding hole 64. On the right hand side of FIG. 8, one of the second pins 82 is shown received in one of the corresponding holes 66. As can be seen, the diameter of the second pins 82 is very similar to that of the corresponding hole 66 of the connector body so that a press fit connection can be achieved. To achieve a pressfit connection, each pressfit pin is square in cross-section whilst the holes have a round cross-section. The relative dimensions are such that the square pins are forced into the round holes and are deformed. This results in a snug fit between the pins and the openings. Any other suitable cross-sectional shapes can be used for the second type of pins and the associated holes.

The diameter of the first and second openings may be different with the diameter of the first and second pins being the same or different. Alternatively the diameter of the first and second openings may be the same with the diameter of the first and second pins being different.

Reference is made to FIG. 9 which shows the pin strip 78 when connected to the connector body 50. For illustrative purposes, part of the projecting portion 62 and part of the pin strip 78 have been cut away to show more clearly the connection between the pin strip 72 and the connector body 50.

As can be seen from FIG. 9, the second pins 82 generally extend through the projecting portion 62 with only a relatively short portion extending out of the lower side 70 of the projecting portion 62. On the other hand, the first pins 80 extend through the projecting portion 62 to a point which is below the bottom of the respective feet 68. The supporting portion 84 generally rests on the projecting portion 62 or may be spaced a small distance thereabove;

Reference will now be made to FIG. 10 which shows the connector as connected to a printed circuit board 88. The first pins 80 are arranged to extend through corresponding holes 90 and are retained in place using a through hole reflow technique. With the through hole reflow technique, solder paste is printed onto the printed circuit board 88 including in the holes 90. The first pins 80 are pushed through this solder paste. This solder paste is then heated so that a secure connection is achieved between the printed circuit board 88 and the first pins 80 by means of the solder. In the preferred embodiment of the invention, the solder is warmed by causing hot air to flow across the surface of the printed circuit board. The provision of the feet 68 means that the body 50 of the connector 40 is raised above the surface of the printed circuit board so that the area below the connector 40 can be heated. This means that a secure connection between the first pins 80 and the printed circuit board can be achieved as the solder is sufficiently heated.

The signal lines 91 are accommodated within the connector: body 50 within a cylindrical insulator 92. The cylindrical insulator 92 has a diameter which corresponds to that of the first part 52 and, the part of the second part 54 up to the step 76. The step 76 prevents the insulator 92 from moving toward the end of the second part 54. The signal lines will pass through the entire length of the connector body 50 and will be attached to external circuitry in any suitable manner. The other end of the signal lines 91 are connected to the printed circuit board 88 via a solder connection 94. In particular, the end of each of the signal lines 91 defines a L shape and the bottom of that L shape is attached to the printed circuit board using any suitable technique such as the surface mounting technique described hereinbefore. Alternatively, the signal lines (for example signal electrodes) can be connected directly to the printed circuit board using a through hole reflow technique as described hereinbefore.

The connector body can be made of any suitable material Generally, the connector is required to be electrically conductive and nonferrous. For example, the connector could be made of copper or brass plating may be required. Alternatively, the connector could be made of a material such as aluminium or an alloy of aluminium and coated with a suitably conductive material.

The pin strip may be made of the same material or a different material to the connector body. The connector body may be made of a relatively soft material whilst the pin strip is made either of a soft material or a relatively hard material. It is of course possible that the connector body may be made of a hard material. The pin strip would then be of either a soft material or a hard material. It should be noted that if both the connector body and the pin strip are of hard material, the insertion force, that is the force required to put the pin strip in place relative to the connector body will be greater than that required if one or both of those components are of a soft material.

Generally, the holding force provided by a press fit connection is equal to half of the applied force. The connector body and pin strip are preferably connected to each other prior to the fitting of the connector to a printed circuit board. Indeed, it is preferred that the manufacturer of the connector fit the pin strip to the connector body before supply to a customer.

In the embodiment shown hereinbefore, a nut is provided. However, in some embodiments of the present invention, the nut size can be reduced or omitted.

The connector body (without any nut) is preferably made as a single piece using any suitable machining, moulding or casting technique.

The connector shown in the accompanying drawings is typically used in the base station of a mobile telecommunications network. Base stations are often provided in relatively unprotected environments. Accordingly, the connection between the connector and the printed circuit board must be secure.

The connector may be used for clock frequency application. The circuitry may therefore comprise signal electrodes. The signal lines may thus be used for receiving a clock frequency. The connector is particularly applicable to radio frequency applications within a base transceiver station.

The connector embodying the present invention can be mounted to the printed circuit board in an automated assembly. In particular, the connector, is due to its construction, much smaller than that of the prior art. Accordingly, the same or similar assembly machines which are used to place integrated circuit chips on the printed circuit board can also handle the connector. As the connector is connected to the printed circuit board using the solder reflow technique, no separate process step is required as this technique is used to simultaneously attach a number of components and not just the connector, to the printed circuit board.

1. A connector for connecting circuitry to a surface, said connector comprising: a one piece body, said one piece body defining a cavity in which a portion of said circuitry is, in use arranged to be received, said cavity being defined by said one piece body; and fixing means for fixing said connector to said surface.

2. A connector for connecting circuitry to a surface, said connector comprising a body which is arranged to receive a first portion of said circuitry, said body having a first opening, and a second opening, wherein in use, a second portion of said circuitry is outside said connector body and is connected to said first portion via said first opening and a third portion of said circuitry is connected to said first portion via said second opening and is connected to said surface.

3. A connector for connecting circuitry to a surface, said connector comprising: a body which is arranged to receive at least a portion of said circuitry; and at least one spacer so that when said circuitry is connected to said surface, said body is spaced from said surface.

4. A connector for connecting circuitry to a surface, said connector comprising: a body which is arranged to receive at least a portion of said circuitry; and at least one pin member comprising a plurality of pins which are connected together at one end region, said body having a plurality of openings for receiving at least some of said pins, wherein in use at least one of said pins is used to fix said body to said surface.

5. A connector as claimed in any of claims 2 to 4, wherein said body is a one piece body.

6. A connector as claimed in any one of claims 1, 3, 4 or 5, wherein said body is arranged to receive a first portion of said circuitry, said body having a first opening and a second opening, wherein in use, a second portion of said circuitry is outside said connector body and is connected to said first portion via said first opening and a third portion of said circuitry is connected to said first portion via said second opening and is connected to said surface.

7. A connector as claimed in any one of claims 1, 2, 4, 5 or 6, wherein at least one spacer is provided so that when said circuitry is connected to said surface, said body is spaced from said surface.

8. A connector as claimed in claim 3 or claim 7, wherein said at least one spacer comprises a plurality of feet.

9. A connector as claimed in claim 8, wherein four feet are provided.

10. A connector as claimed in claim 7, 8 or 9, wherein said at least one spacer is integral with said body.

11. A connector as claimed in any one of claims 1 to 3 or 5 to 10, wherein at least one pin member is provided, said pin member comprising a plurality of pins which are connected together at one end region, said body having a plurality of openings for receiving at least some of said pins, wherein in use at least one of said pins is used to fix said body to said surface.

12. A connector as claimed in claim 4 or 11, wherein two pin members are provided.

13. A connector as claimed in claim 4, 11 or 12, wherein in use at least one pin is connected to said circuit board by a solder connection.

14. A connector as claimed in any of claims 4, 11 or 12, wherein the plurality of pins of the or each pin member are arranged in a row.

15. A connector as claimed in claim 4, 11 12, 13 or 14, wherein the or each pin member comprises a first type of pin for connecting said pin member to said body and a second type of pin for connecting said connector to said surface.

16. A connector as claimed in claim 15, wherein the first type of pin are arranged to make electrical contact with the body of the connector.

17. A connector as claimed in claim 15 or 16, wherein the first type of pin is received in an opening of said connector body with a press fit connection.

18. A connector as claimed in claim 15, 16 or 17, wherein the or each opening of said body for said second type of pin is dimensioned to allow the second type of pin to pass therethrough.

19. A connector as claimed in any of claims 15 to 18, wherein the first type of pin is shorter than the second type of pin.

20. A connector as claimed in any one of claims 15 to 19, wherein a plurality of the first type of pin and a plurality of said second type of pin are provided and said first and second type of pins are alternatively arranged.

21. A connector as claimed in any one of the preceding claims, wherein the portion of the circuitry received in said body comprises signal pins.

22. A connector as claimed in claim wherein in use said connector is arranged to establish an electrical connection between said circuitry and said surface.

23. A connector as claimed in any one of the preceding claims, wherein said connector body comprises metal.

24. A connector as claimed in claim 23, wherein said connector body comprises one or more of the following materials: brass; copper; and aluminum.

25. A connector as claimed in any one of the preceding claims wherein an upper surface of said connector is flat.

26. A connector as claimed in any one of the preceding claims, wherein said connector comprises an insulator part in said body for positioning said at least a portion of said circuitry in said body.

27. A connector as claimed in any one of the preceding claims, wherein said surface is a printed circuit board.

28. A base transceiver station incorporating a connector as claimed in any one of the preceding claims.
